(19) United States
(12) Patent Application Publication
(10) Pub. No.: US 2014/0046472 A1
(43) Pub. Date: Feb. 13, 2014

(54) DISK TRANSFER UNIT AND INSPECTION APPARATUS

(71) Applicant: Hitachi High-Technologies Corporation, Tokyo (JP)

(72) Inventors: Kazufumi NAKAMURA, Kamisato-machi (JP); Toshimitsu SHIRAISHI, Kamisato-machi (JP); Naoaki YAMASHITA, Kamisato-machi (JP); Mutuo KUROIWA, Kamisato-machi (JP); Tsutomu NAKADAI, Kamisato-machi (JP)

(73) Assignee: Hitachi High-Technologies Corporation, Tokyo (JP)

(21) Appl. No.: 13/962,121

(22) Filed: Aug. 8, 2013

(30) Foreign Application Priority Data
Aug. 10, 2012 (JP) 2012-177830

(51) Int. Cl. G06Q 10/08

(52) U.S. Cl. CPC G06Q 10/08
USPC 700/110

(57) ABSTRACT

The purpose of the present invention provides a disk transfer unit and inspection apparatus that can transfer a plurality of disks and increase throughput.

The present invention includes: a supply/discharge/transfer portion fetching disks from a disk supply portion and discharging inspected disks to a predetermined place; an inspection unit transfer portion transferring the disks within an inspection unit; and a delivery/transfer portion transferring the disks between the disk supply/discharge/transfer portion and the inspection unit transfer portion. The delivery/transfer portion comprises: a base having a rotational center and is formed in an arc-like shape with center at the rotational center and providing with even numbers of disk mounting portions for mounting the disks and a driving portion for moving the base up and down and rotating the base about the rotational center, and transfers the disks between the supply/discharge/transfer portion and the inspection unit transfer portion.

### BACKGROUND OF THE INVENTION

The present invention relates to a disk transfer unit and inspection apparatus. Particularly, the invention relates to supply/discharge of disks to/from the disk transfer unit and the inspection apparatus.

Plural pairs of arms for holding an outer circumference of a disk on the both sides are disposed in an upright position and arranged in a row with a predetermined spacing in an axial direction. A plurality of disks, each held by each pair of arms, are transferred in one axial direction while surfaces of the disks being transferred are scanned in a direction perpendicular to the one axial direction for detection of any defects (JP-A No. 2008-116340).

### SUMMARY OF THE INVENTION

A conventional disk inspection apparatus ((JP-A No. 2008-116340)) is a system which transfers the disks one by one in one direction. However, to inspect a plurality of disks, the conventional disk inspection apparatus is to be provided with a plurality of linear movement bases. Thus, the apparatus is increased in size. If the apparatus is to achieve increased throughput without being increased in size, any further throughput increase is impossible.

An object of the invention is to provide a disk transfer unit or inspection apparatus that can transfer a plurality of disks and increase throughput.

For solution to the above problem, the invention has at least the following features.

A disk transfer unit according to an aspect of the invention includes: a supply/discharge/transfer portion fetching disks from a disk supply portion and discharging inspected disks to a predetermined place; an inspection unit transfer portion transferring the disks within an inspection unit; and a delivery/transfer portion transferring the disks between the disk supply/discharge/transfer portion and the inspection unit transfer portion, wherein the delivery/transfer portion comprises: a base having a rotational center and is formed in an arc-like shape with center at the rotational center and providing with even numbers of disk mounting portions for mounting the disks and a driving portion for moving the base up and down and rotating the base about the rotational center, and transfers the disks between the supply/discharge/transfer portion and the inspection unit transfer portion.

The delivery/transfer portion transfers an uninspected disk having not been inspected and an inspected disk having not been inspected.

In addition, the delivery/transfer portion transfers a plurality of the uninspected disks and a plurality of the inspected disks, and alternately places the uninspected disks and the inspected disks on the disk mounting portions.

The base is shaped like a fan and the disk mounting portions are provided on a side of the fan shape.

An inspection apparatus according to an aspect of the invention includes: the above-described disk transfer unit; and an inspection unit including an inspection optical system for inspecting the disks transferred by the inspection unit transfer portion.

The disk transfer unit and inspection apparatus according to the invention are adapted for efficient transfer of a plurality of disks without involving disk collision or disk stagnation.

### BRIEF DESCRIPTION OF THE DRAWINGS

FIG. 1 is a diagram showing an overall layout of an inspection apparatus according to one embodiment of the invention;

FIG. 2 is a block diagram showing a control system and operations of the system mainly composed of a disk transfer unit according to one embodiment of the invention;

FIG. 3 is a group of diagrams illustrating operations of the disk transfer unit, focusing on a delivery holder constituting a delivery/transfer portion according to one embodiment of the invention; and

FIG. 4 is a group of diagrams illustrating the operations of the disk transfer unit, focusing on the delivery holder constituting the delivery/transfer portion according to one embodiment of the invention.

### DESCRIPTION OF THE PREFERRED EMBODIMENTS

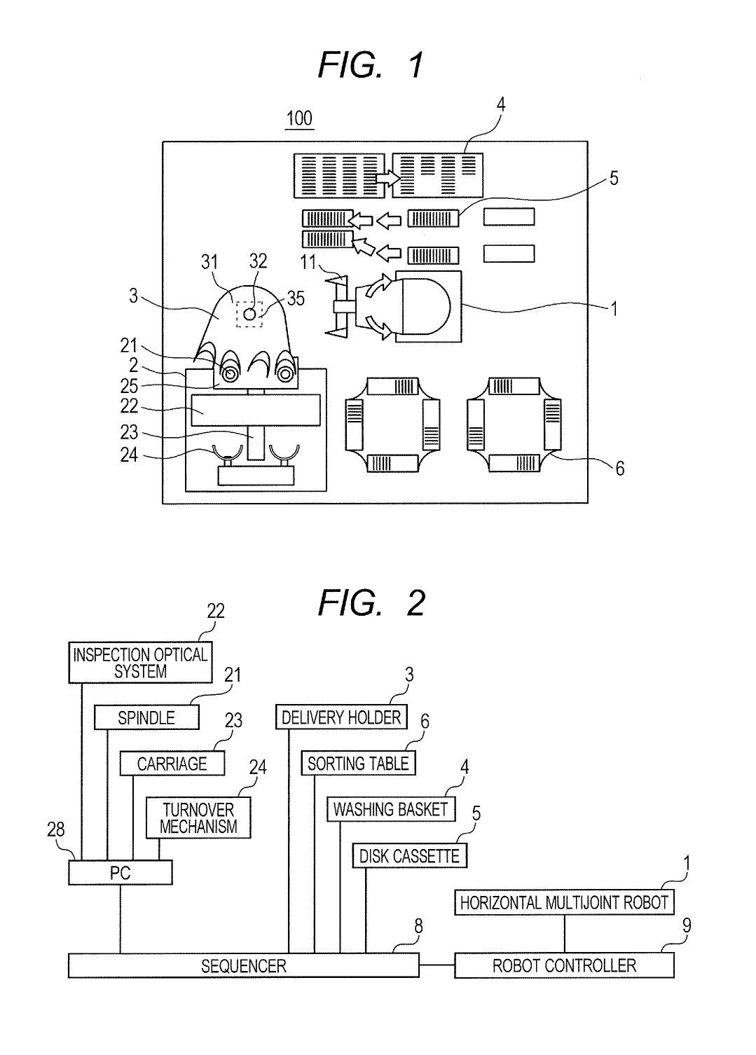

A disk transfer unit and inspection apparatus according to the invention are described with reference to the accompanying drawings. FIG. 1 is a diagram showing an overall layout of an inspection apparatus according to one embodiment of the invention. An inspection apparatus 100 of the invention includes a horizontal multijoint robot 1 having a hand capable of holding two disks; an inspection unit 2 for inspecting various characteristics of the disk, a delivery holder 3 as one example of a delivery/transfer portion having functions to move up and down and to rotate horizontally while holding four disks, a washing basket 4 accommodating, for example, 100 disks to be supplied, a disk cassette 5 storing good-quality disks therein after inspection and a sorting table 6 for ranking defective disks after inspection.

The horizontal multijoint robot 1 has a robot hand 11 which holds the circumference of the disk with two claws and releases the disk. The horizontal multijoint robot 1 uses this robot hand 11 to fetch uninspected disks from the washing basket 4, to deliver the disks to the delivery holder 3, to receive inspected disks from the delivery holder 3, and to set the disks on a sorting table 6. At this time, good-quality disks are stored in the disk cassette 5. Thus, the horizontal multijoint robot 1 constitutes an example of a disk supply/discharge/transfer portion that supplies the uninspected disks to the inspection unit 2 through the delivery holder 3 and discharges the inspected disks to predetermined place through the delivery holder 3.

The delivery holder 3 as a feature of the embodiment includes a base 31 having a plurality of disk mounting portions capable of retaining the disks and a driving mechanism 35 rotating the base 31 about a rotational center 32 and moving up and down the base 31. The delivery holder 3 is capable of retaining four disks at a time such that at the time of delivery/reception of disks to/from the inspection unit 2, the delivery holder 3 can receive two inspected disks while retaining two uninspected disks to be supplied to the inspection unit 2. At the time of delivery/reception to/from the inspection unit 2, the delivery holder 3 vertically moves so as to receive two disks from two spindles 21 provided at the inspection unit 2. Subsequently, the delivery holder 3 horizontally rotates to bring the two uninspected disks into face-to-face relation to the two spindles 21 and mounts the two uninspected disks to the two spindles 21.

The four disk mounting portions of the delivery holder 3 are arranged in a manner such that a disk supplying holder and a disk receiving holder alternate with each other in order to allow the delivery holder 3 to deliver/receive disks by movement through the minimum horizontal rotational angle. As a result, disk transfer operation time can be reduced, increasing throughput.

Of the four disk mounting portions of the delivery holder 3, two disk mounting portions at one end side may be used as the disk supplying holders while the other two disk mounting portions at the other side end may be used as the disk receiving holders. In this case, the horizontal rotational angle of the delivery holder 3 is increased and hence, the throughput is decreased as compared with the above-described case. However, a stage 25 to be described hereinafter and the robot hand 11 can be reduced in size.

The number of disk mounting portions is not limited to four but may be any multiples of 2 (any even number) because what is required is that the number of the disk supplying holders is equal to that of the disk receiving holders.

As with the delivery/reception of disks to/from the inspection unit 2, the delivery holder 3 delivers two inspected disks to the horizontal multijoint robot 1 and receives two uninspected disks from the horizontal robot 1.

The delivery holder 3 performs the disk delivery/reception alternately with the inspection unit 2 and the horizontal multijoint robot 1. By doing so, the inspection unit 2 and the horizontal multijoint robot 1 are little affected by the operation timing of the counterpart. This eliminates wasted time such as that of stagnation from the disk transfer operation time, contributing to the increase in throughput.

Further, the transfer time of the delivery holder 3 can be minimized by locating the horizontal multijoint robot 1 and the inspection unit 2 at 90°-angular positions relative to the delivery holder 3. As a matter of course, the horizontal multijoint robot and the inspection unit may be located at another-angular positions.

The inspection unit 2 includes the stage 25 equipped with the above-described two spindles 21, an inspection optical system 22 for disk inspection, a turnover mechanism 24 for inspection of the top and bottom sides of the disk and a carriage 23 for moving the stage 25. The carriage 23 constitutes an example of an inspection unit transfer portion jointly with the stage 25 and reciprocates the disks between a place to deliver/receive disks to/from the delivery holder 3 and the turnover mechanism 24. The inspection optical system 22 spirally inspects surface defects on the disk while rotating the spindles 21 at high speed during the passage of the stage 25 through a lower part of the inspection optical system 22. The top side of the disk is inspected during moving to the turnover mechanism 24. The disk is inverted by the turnover mechanism 24 and the bottom side of the disk is inspected during moving to the place to deliver/receive disks to/from the delivery holder 3.

The horizontal multijoint robot 1, the washing basket 4 accommodating the disks to be supplied and the disk cassette 5 storing the good-quality disks after inspection, and the like are disposed on the right side of the delivery holder 3 as seen in FIG. 1. However, if these components are disposed on the left side of the delivery holder as seen in the figure, the arrangement is likely to produce the same effects.

Next, a control system and operations of the system mainly composed of the disk transfer unit according to one embodiment of the invention are described with reference to a block diagram shown in FIG. 2. The disk transfer unit of the embodiment includes the supply/discharge/transfer portion, the delivery/transfer portion and the inspection unit transfer portion which are illustrated in FIG. 1.

A sequencer 8 controls the delivery holder 3. The sequencer 8 operates the horizontal multijoint robot 1 by issuing a command to a robot controller 9. In response to the command from the robot controller 9, the horizontal multijoint robot 1 fetches the uninspected disks from the washing basket 4, delivers the disks to the delivery holder 3, and delivers the inspected disks to the disk cassette 5 or the sorting table 6.

The sequencer 8 also controls cassette transfer from the washing basket 4 and to the disk cassette 5. The washing basket 4 contains therein the uninspected disks, which are sequentially extracted by the horizontal multijoint robot 1. When the washing basket 4 becomes empty, the horizontal multijoint robot 1 displaces the empty washing basket 4 and transfers another washing basket 4 accommodating the uninspected disks to a predetermined position from which the robot hand 11 can carry away the uninspected disks. The inspected disks determined to be of good quality are stored in the disk cassette 5 when the inspection is completed. When the disk cassette 5 is filled with the inspected disks, the disk cassette 5 thus filled is displaced and replaced by an empty disk cassette 5 which allows the robot hand 11 to store the inspected disks therein.

The sequencer 8 further controls the rotation angle and stoppage of the delivery holder 3. A detailed description on the operations of the delivery holder 3 is made hereinafter. The sequencer 8 determines whether the sorting table 6 is full of defective disks or not. When the sorting table is filled up, the sequencer puts the defective disks in an empty sorting table 6.

The sequencer 8 also outputs to a personal computer (PC) 28 a signal for controlling the inspection unit 2. The operations of the inspection unit 2 are controlled by one personal computer 28. This is to provide control in which wasteful stagnation time is eliminated by omitting signal communication with any other control unit. The personal computer 28 controls the operations of the spindles 21, inspection optical system 22, carriage 23 and turnover mechanism 24. The inspection optical system 22 spirally inspects surface defects on the disks by bringing the disks received on the spindles 21 while rotating the spindles 21 at high speed and during moving the disks through the lower part of the inspection optical system.

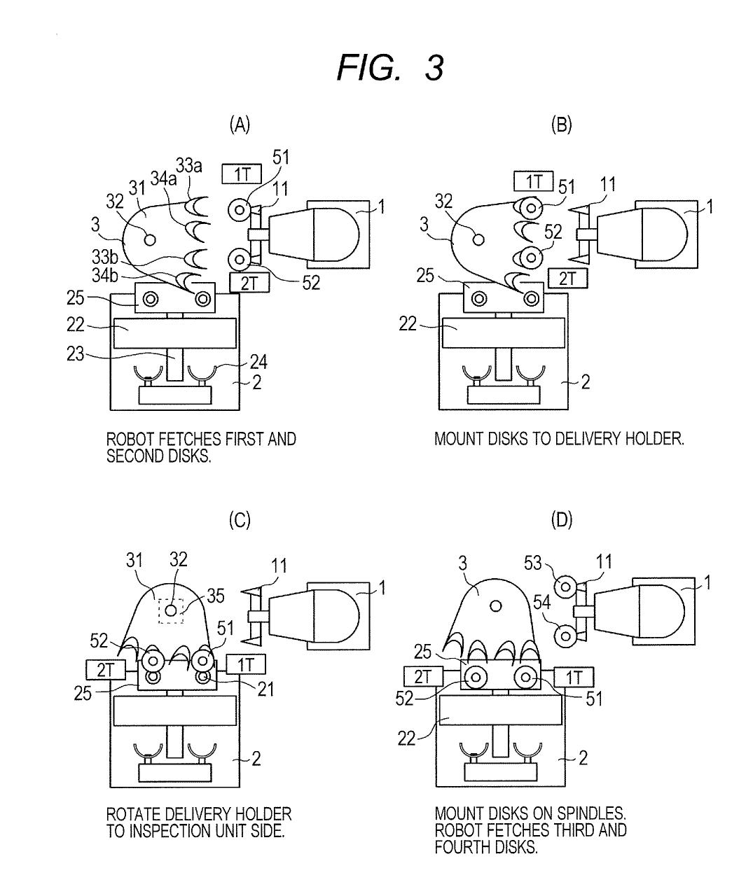

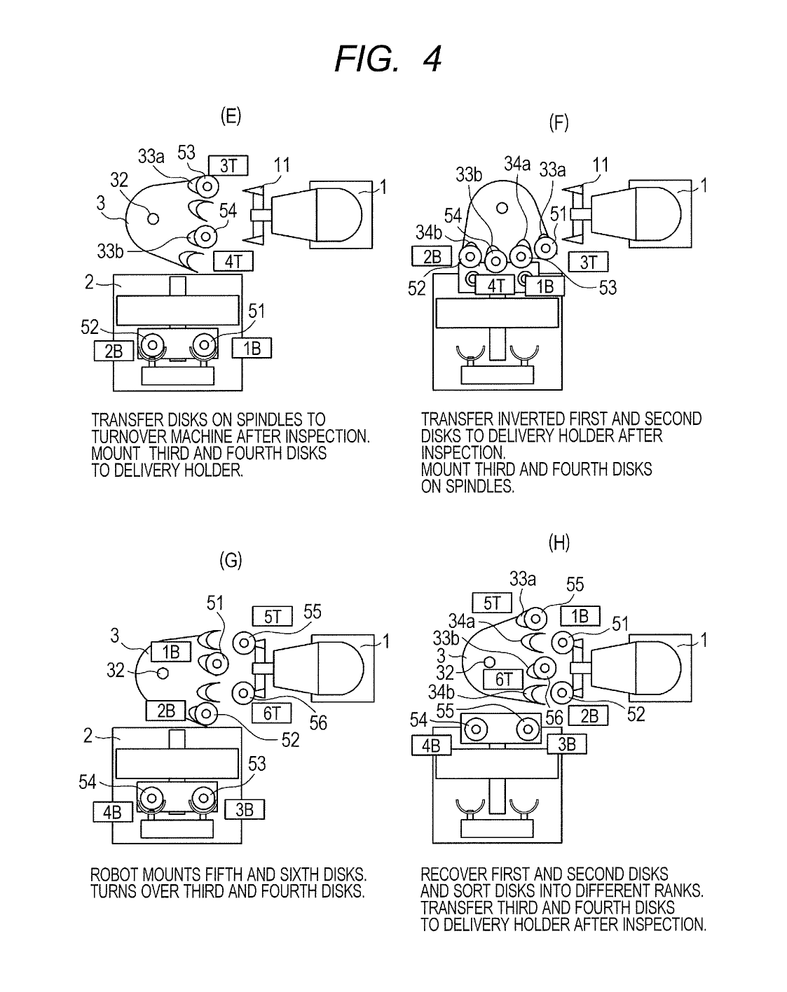

Now referring to FIG. 3 and FIG. 4, description is made on the operations of the disk transfer unit, focusing on the delivery holder 3 constituting the delivery/transfer portion. Of the symbols such as “1T” and “2B” shown in FIG. 3 and FIG. 4, the numerals denote the order of disks delivered to the disk transfer unit . The character “T” denotes the top side of the disk delivered to the disk transfer unit, while the character “B” indicates that the disk was inverted to turn the bottom side up.

The horizontal multijoint robot 1 rotates and the robot hand 11 stretches its arms and fetch two uninspected disks 51, 52 of the first cycle from the washing basket 4 (FIG. 3A).

The robot hand 11 mounts the inspection disks 51, 52 on uninspected-disk mounting portions 33a, 33b that carries the inspection disks 51, 52. At this time, the disk 51 of the first cycle is mounted to the uninspected-disk mounting portion 33a and the disk 52 of the first cycle is mounted to the uninspected-disk mounting portion 33b. In this embodiment, the disks 51, 52 of the first cycle are not mounted in an adjoining relation but in a manner to allow the insertion of another disk between the disks 51, 52 of the first cycle. As a result, transfer time for disk change can be reduced because the robot needs to rotate through only a small angle for disk change (FIG. 3B).

The delivery holder 3 rotates 90° clockwise about the rotational center 32. The stage 25 of the inspection unit 2 moves to receive the disks 51, 52 of the first cycle (FIG. 3C).

The disks 51, 52 of the first cycle are mounted on the spindles 21 that rotate the disks as holding the disks at inner circumferences of disk holes. When the disks 51, 52 of the first cycle are mounted on the spindles 21, the disks 51, 52 of the first cycle, with the inner circumferences of the respective holes thereof fitted with the spindles 21, are retained by the spindles 21, respectively. On the other hand, the horizontal multijoint robot 1 fetches disks 53, 54 of the second cycle from the washing basket 4, getting ready for disk supply to the delivery holder 3. Subsequently, the stage 25 moves to the inspection optical system 22, although omitted the figure. The disks 51, 52 of the first cycle have the respective top sides thereof inspected by being rotated on the respective spindles 21 (FIG. 3D).

The delivery holder 3 rotates 90° counter-clockwise about the rotational center 32. The robot hand 11 of the horizontal multijoint robot 1 mounts the disks 53, 54 of the second cycle on the uninspected-disk mounting portions 33a, 33b provided at the base 31 of the delivery holder 3. When the inspection on the respective top sides of the disks 51, 52 of the first cycle is completed, the stage 25 with the two disks mounted moves to the turnover mechanism 24. The turnover mechanism 24 starts an operation of inverting the disks 51, 52 of the first cycle as holding outer circumferences of the disks 51, 52 of the first cycle. When the operation of inverting the disks 51, 52 of the first cycle is completed, the disks 51, 52 of the first cycle are retained on the spindles 21 by bringing the inner circumferences of the holes of the disks 51, 52 of the first cycle into fitting engagement with the spindles 21. The disks 51, 52 of the first cycle are placed with the uninspected bottom sides up, respectively. When the disks 51, 52 of the first cycle are retained by the spindles 21, the turnover mechanism 24 disengages from the retained outer circumferences of the disks 51, 52 of the first cycle (FIG. 4E).

The bottom sides of the disks 51, 52 of the first cycle are inspected by the inspection optical system 22. When the inspection of the disks 51, 52 of the first cycle is completed, the stage 25 moves to the delivery position to deliver the inspected disks 51, 52 of the first cycle to the delivery holder 3.

On the other hand, the delivery holder 3 rotates clockwise about the rotational center 32. At this time, the two uninspected disks are already mounted on the delivery holder 3. However, the delivery holder 3 needs to receive the inspected disks 51, 52 in first. Hence, the delivery holder 3 rotates by a rotational angle corrected from 90° of the correct position of the uninspected-disk mounting portions 33a, 33b so as to bring inspected-disk mounting portions 34a, 34b in front of the stage 25.

The inspected disks 51, 52 of the first cycle are released from the fitting engagement with the spindles 21. The inspected disks 51, 52 of the first cycle with the bottom sides up are mounted on the inspected-disk mounting portions 34a, 34b. When mounting of the inspected disks 51, 52 of the first cycle is completed, the delivery holder 3 rotates about the rotational center 32 so as to bring the uninspected-disk mounting portions 34a, 34b in front of the stage 25. The disks 53, 54 of the second cycle are delivered to the stage 25. At this time, the disks 53, 54 of the second cycle are retained on the spindles 21 by bringing the inner circumferences of the holes of the disks 53, 54 of the first cycle into fitting engagement with the spindles 21 (FIG. 4F).

The delivery holder 3 rotates counter-clockwise about the rotational center 32. At this time, the delivery holder 3 stops at position to set the uninspected-disk mounting portions 33a, 33b in front of the robot hand 11.

On the other hand, the stage 25 moves to the inspection optical system 22, which inspects the top sides of the disks 53, 54 of the second cycle. When the inspection of the top sides of the disks 53, 54 of the second cycle is completed, the stage 25 moves to the turnover mechanism 24 for inspection of the bottom sides of the disks 53, 54 of the second cycle. The turnover mechanism 24 removes the disks 53, 54 of the second cycle from the spindles 21 by holding the disks 53, 54 on the outer circumferences. Subsequently, the turnover mechanism 24 starts the operation of inverting the disks 53, 54 of the second cycle. When the operation of inverting the disks 53, 54 of the second cycle is completed, the disks 53, 54 of the second cycle are retained on the spindles 21 by bringing the inner circumferences of the holes of the disks 53, 54 of the second cycle into fitting engagement with the spindles 21. The disks 53, 54 of the second cycle are placed with the uninspected bottom sides up, respectively. When the disks 53, 54 of the second cycle are retained on the spindles 21, the turnover mechanism 24 disengages from the retained outer circumferences of the disks 53, 54 of the second cycle (FIG. 4G).

On the other hand, the robot hand 11 holds disks 55, 56 of the third cycle to deliver the disks so as to the delivery holder 3 (FIG. 4G).

When the disks 55, 56 of the third cycle are mounted on the uninspected-disk mounting portions 33a, 33b, respectively, the robot hand 11 is free of disks. The delivery holder 3 rotates about the rotational center 32 so as to bring the inspected-disk mounting portions 34a, 34b in front of the robot hand 11. The robot hand 11 receives the two inspected disks 51, 52 of the first cycle from the inspected-disk mounting portions 34a, 34b, respectively. When the inspection unit 2 completes the inspection on the respective bottom sides of the disks 53, 54 of the second cycle, the stage 25 moves to the place to deliver/receive disks to/from the delivery holder 3 (FIG. 4H).

The delivery holder 3 repeats the operations in the order of that shown in FIG. 4H and those shown in FIG. 4E to FIG. 4G.

According to the embodiment of the invention as described above, the disk transfer unit or the inspection apparatus that can increase throughput is provided because the embodiment is capable of efficient transfer of plural disks without disk collision or stagnation.

What is claimed is:

1. A disk transfer unit comprising:
a supply/discharge/transfer portion fetching disks from a disk supply portion and discharging inspected disks to a predetermined place;
an inspection unit transfer portion transferring the disks within an inspection unit; and a delivery/transfer portion transferring the disks between the disk supply/discharge/transfer portion and the inspection unit transfer portion,
wherein the delivery/transfer portion comprises: a base having a rotational center and is formed in an arc-like shape with center at the rotational center and providing with even numbers of disk mounting portions for mounting the disks and a driving portion for moving the base up and down and rotating the base about the rotational center, and transfers the disks between the supply/discharge/transfer portion and the inspection unit transfer portion.

2. The disk transfer unit according to claim 1, wherein the delivery/transfer portion transfers an uninspected disk having not been inspected and an inspected disk having not been inspected.

3. The disk transfer unit according to claim 2, wherein the delivery/transfer portion transfers a plurality of the uninspected disks and a plurality of the inspected disks, and alternately places the uninspected disks and the inspected disks on the disk mounting portions.

4. The disk transfer unit according to claim 2, wherein the delivery/transfer portion transfers a plurality of the uninspected disks and a plurality of the inspected disks, and is provided with the disk mounting portions at one end side thereof for mounting the uninspected disks and with the disk mounting portions at the other side end thereof for mounting the inspected disks.

5. The disk transfer unit according to claim 1, wherein the base is shaped like a fan and the disk mounting portions are provided on a side of the fan shape.

6. The disk transfer unit according to claim 2, wherein the base is shaped like a fan and the disk mounting portions are provided on a side of the fan shape.

7. The disk transfer unit according to claim 3, wherein the base is shaped like a fan and the disk mounting portions are provided on a side of the fan shape.

8. The disk transfer unit according to claim 4, wherein the base is shaped like a fan and the disk mounting portions are provided on a side of the fan shape.

9. The disk transfer unit according to claim 1, wherein the even number is 4.

10. The disk transfer unit according to claim 2, wherein the even number is 4.

11. The disk transfer unit according to claim 3, wherein the even number is 4.

12. The disk transfer unit according to claim 4, wherein the even number is 4.

13. An inspection apparatus comprising: the disk transfer unit according to claim 1; and an inspection unit comprising an inspection optical system for inspecting the disks transferred by the inspection unit transfer portion.

14. An inspection apparatus comprising: the disk transfer unit according to claim 2, and an inspection unit comprising an inspection optical system for inspecting the disk transferred by the inspection unit transfer portion.

15. An inspection apparatus comprising: the disk transfer unit according to claim 3, and an inspection unit comprising an inspection optical system for inspecting the disks transferred by the inspection unit transfer portion.

16. An inspection apparatus comprising: the disk transfer unit according to claim 4, and an inspection unit comprising an inspection optical system for inspecting the disks transferred by the inspection unit transfer portion.

17. The inspection apparatus according to claim 13, wherein the inspection unit is provided with a turnover mechanism for inverting the disks transferred to place on the opposite side of delivery place from the delivery/transfer portion for the inspection optical system.

18. The inspection apparatus according to claim 14, wherein the inspection unit is provided with a turnover mechanism for inverting the disks transferred to place on the opposite side of delivery place from the delivery/transfer portion for the inspection optical system.

19. The inspection apparatus according to claim 15, wherein the inspection unit is provided with a turnover mechanism for inverting the disks transferred to place on the opposite side of delivery place from the delivery/transfer portion for the inspection optical system.

20. The inspection apparatus according to claim 16, wherein the inspection unit is provided with a turnover mechanism for inverting the disks transferred to place on the opposite side of delivery place from the delivery/transfer portion for the inspection optical system.
